(19) United States
(12) Patent Application Publication
(10) Pub. No.: US 2019/0281362 A1
(43) Pub. Date: Sep. 12, 2019

(54) FOREGROUND TRAINING IN A HYBRID FIBER-COAXIAL NETWORK WITH REMOTE-PHY

(71) Applicant: Maxlinear, Inc., Carlsbad, CA (US)

(72) Inventors: Kenneth Scott Wiley, Carlsbad, CA (US); Steven Krapp, Naperville, IL (US); Eitan Tsur, Tel Aviv (IL); Sridhar Ramesh, Carlsbad, CA (US)

(21) Appl. No.: 16/294,244

(22) Filed: Mar. 6, 2019

Related U.S. Application Data
(60) Provisional application No. 62/639,518, filed on Mar. 7, 2018.

(51) Int. Cl. H04N 21/61; H04L 12/28; H04N 21/239

(52) U.S. Cl. CPC H04N 21/615; H04N 21/6118; H04N 21/239; H04N 21/6168; H04L 12/2801

(57) ABSTRACT

A remote PHY comprises circuitry operable to communicate with a converged cable access platform and a plurality of cable modems in accordance with Data Over Cable Service Interface Specification (DOCSIS®). The remote PHY comprises buffer circuitry operable to buffer signals to be transmitted to one or more of the plurality of cable modems. The remote PHY may comprise subcarrier insertion circuitry operable to manipulate the contents of the buffer circuitry such that the remote PHY is scheduled to transmit, during a determined time interval, subcarriers having determined characteristics. The subcarriers having determined characteristics may be zero-bit-loaded subcarriers.

### PRIORITY CLAIM

This application claims the benefit of priority to U.S. Provisional Patent Application 62/639,518 filed Mar. 7, 2018, which is hereby incorporated herein by reference in its entirety.

### INCORPORATION BY REFERENCE

This application makes reference to:

U.S. patent application Ser. No. 15/938,937 titled “Full Duplex DOCSIS Cable Modem Echo Cancellation with Training” and filed on Mar. 28, 2018, which is hereby incorporated herein by reference in its entirety.

### BACKGROUND

Conventional systems and methods for communications can be overly power hungry, slow, expensive, and inflexible. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY

Systems and methods for foreground training in a hybrid fiber-coaxial network with remote-PHY, substantially as shown in and/or described in connection with at least one of the figures, as set forth more completely in the claims.

Advantages, aspects and novel features of the present disclosure, as well as details of various implementations thereof, will be more fully understood from the following description and drawings.

### BRIEF DESCRIPTION OF THE DRAWINGS

FIG. 1 is a diagram depicting an example hybrid fiber-coaxial (HFC) network.

FIG. 2 shows example frequency plans for a full-duplex Data Over Cable Service Interface Specification (DOCSIS®) network.

FIG. 3 shows example circuitry of a full-duplex DOCSIS® network configured for coordinated cable modem training in accordance with an example implementation of this disclosure.

FIG. 4 illustrates example transceiver circuitry of a full-duplex cable modem operable to perform echo cancellation to help mitigate the effects of ACI and ALI in a full-duplex system.

FIG. 5 is a flow chart illustrating an example process for coordinated training of cable modems in a full-duplex DOCSIS® network.

FIG. 6 illustrates coordinated insertion of zero-bit-loaded subcarriers in a full-duplex DOCSIS® network, in accordance with an example implementation of this disclosure.

### DETAILED DESCRIPTION OF THE INVENTION

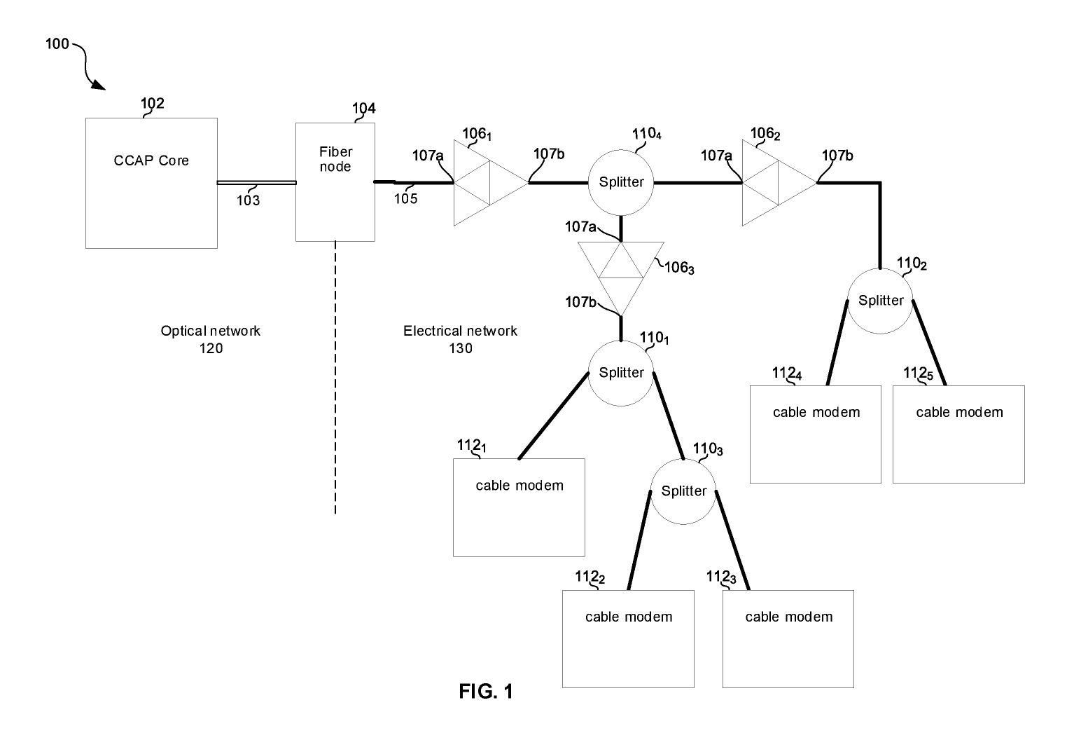

FIG. 1 is a diagram depicting an example hybrid fiber-coaxial (HFC) network. The example HFC network 100 comprises a converged cable access platform (CCAP) core 102, a remote PHY fiber node 104, amplifiers 106₁-106₃, splitters 110₁-110₄, and cable modems 112₁-112₅.

The CCAP core 102 comprises circuitry operable to handle Data Over Cable Service Interface Specification (DOCSIS®) traffic to and from the cable modems 112₁-112₅. The CCAP core 102 is operable to manage the allocation/reservation of frequency bands (resource blocks) on the network 100.

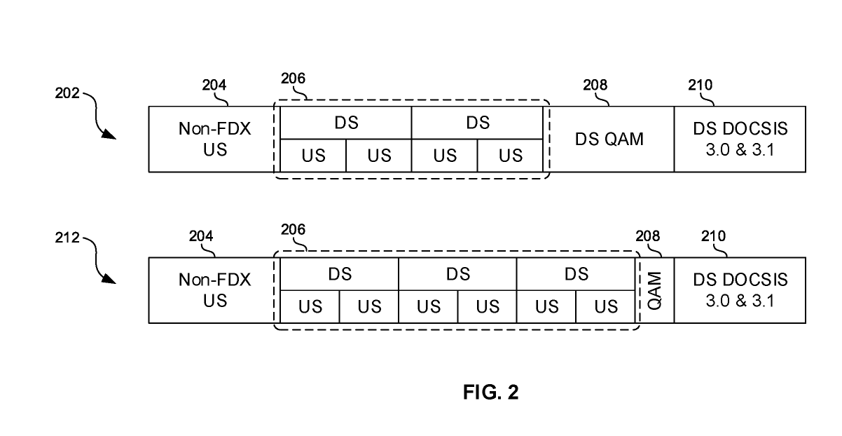

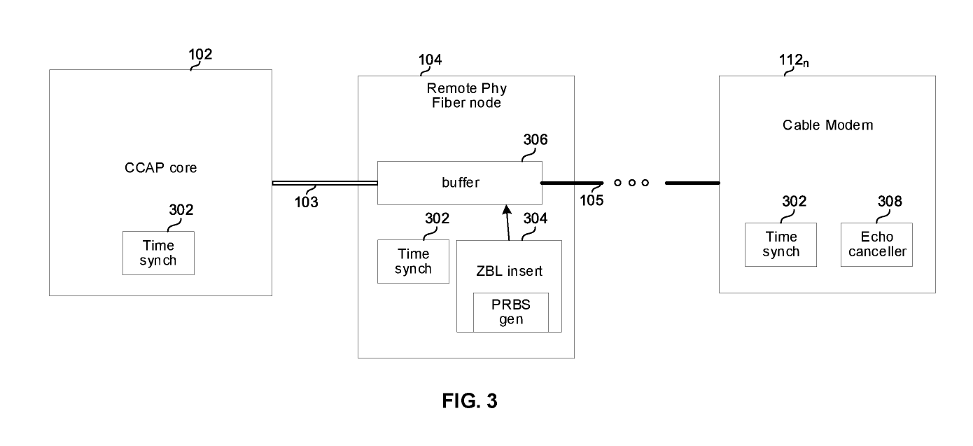

The remote PHY fiber node 104 comprises circuitry operable to provide an interface between the optical network 120 and the electrical network 130. The fiber node 104 is operable to communicate full-duplex on one or more frequency bands on the electrical network 130, as described in more detail below with reference to FIG. 2. The fiber node 104 is operable to support coordinated training of cable modems, as described in more detail below with reference to FIGS. 3-5.

Each of the amplifiers 106₁-106₃ may comprise a bidirectional amplifier which may amplify downstream signals and upstream signals, where downstream signals are input to an amplifier 106ₓ (x being 1, 2, or 3 for the amplifiers shown in FIG. 1) via its upstream interface 107a and output via its downstream interface 107b, and upstream signals are input to an amplifier 106ₓ via downstream interface 107b and output via its upstream interface 107a. The amplifier 106₁, which amplifies signals along the main coaxial “trunk,” may be referred to as a “trunk amplifier.” The amplifiers 106₂ and 106₃, which amplify signals along “branches” split off from the trunk, may be referred to as “branch” or “distribution” amplifiers.

Each of the splitters 110₁-110₄ comprises circuitry operable to output signals incident on each of its interfaces onto each of its other interfaces. Each of the splitters 110₁-110₄ may be a passive or active device which supports bidirectional transfer of signals.

Each of the cable modems 112₁-112₅ is operable to communicate with, and be managed by, the CCAP core 102 in accordance with one or more standards (e.g., DOCSIS®). Each of the cable modems 112₁-112₅ may reside at the premises of a network subscriber.

FIG. 2 shows example frequency plans for full-duplex DOCSIS® network. The two example frequency plans each comprise a band of frequencies 204 that is used only for upstream (US), a full-duplex band of frequencies 206 that are used for downstream and upstream, a band of frequencies 208 used only for downstream cable television (“QAM”) signals 208, and a band of frequencies 210 used for downstream DOCSIS® signals (e.g., per the DOCSIS® 3.0 or 3.1 standard(s)). In an example implementation, the fiber node 104 communicates full-duplex on subbands within band 206, but each cable modem 112ₙ (e.g., each of one or more of modems 112₁-112₅ of FIG. 1) communicates in only one direction on subbands within band 206. Nevertheless, because the subbands in band 206 are dynamically assigned, per cable modem, to either upstream (US) or downstream (DS), a cable modem operating on one or more of the subbands in band 206 must be able to support upstream and downstream on each of the subbands within band 206. This means that a cable modem 112ₙ cannot use fixed diplexer filters for suppressing adjacent channel interference (ACI) and adjacent leakage interference (ALI) on the band 206. Furthermore, configurable diplexer filters are very difficult and costly to implement. Accordingly, the cable modems 112 may comprise echo cancellation circuitry for dealing with ACI and ALI on band 206. For example, the echo cancellation target may be ˜50 dB of margin for ACI and ˜55 dB of margin for ALI to ensure the ability to receive 4K QAM DS.

FIG. 3 shows example circuitry of a full-duplex DOCSIS® network configured for coordinated cable modem training in accordance with an example implementation of this disclosure. Shown again are the CCAP core 102, the remote PHY fiber node 104, and a cable modem 112ₙ.

Each of the CCAP core 102, remote PHY fiber node 104, and cable modem 112ₙ comprise time synchronization circuitry 302 operable to synchronize the devices of the network to a common time base (e.g., using IEEE 1588). Each of the time synchronization circuits 302 may comprise a clock circuit. The implementation of the time synchronization circuitry 302 may be different in each of the devices as long as they have at least one supported synchronization protocol in common.

The fiber node 104 comprises buffer circuitry 306 and zero-bit-loaded subcarriers insertion circuitry 304.

The buffer 306 comprises any suitable type of volatile and/or nonvolatile memory and is operable to buffer signals received from the CCAP core 102 via optical link 103 before transmitting the signals onto the electrical link 105.

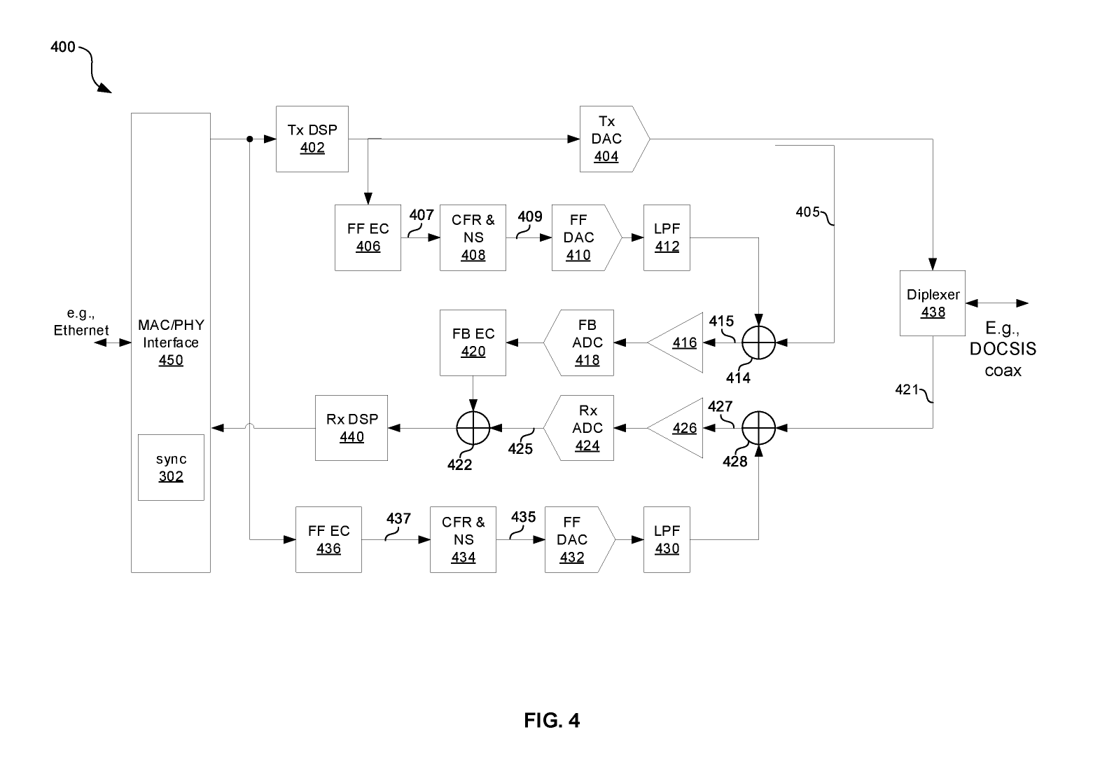

The zero-bit-loaded subcarrier insertion circuitry 304 is operable to insert zero-bit-loaded subcarriers into the buffer 306 such that the zero-bit-loaded subcarriers are transmitted onto link 105 at predetermined times, as described, for example, with respect to FIG. 4 below. A zero-bit-loaded subcarrier may be a subcarrier modulated by a pseudo random binary sequence (PRBS) and thus the zero-bit-loaded subcarrier insertion circuitry may comprise a PRBS generator.

FIG. 4 illustrates example transceiver circuitry of a full-duplex cable modem (e.g., 112ₙ of FIG. 3) operable to perform echo cancellation to help mitigate the effects of ACI and ALI in a full-duplex system. The example circuitry 400 of cable modem 112n comprises diplexer 438, transmit (Tx) digital signal processing (DSP) circuitry 402, upstream (US) digital to analog conversion (DAC) circuitry 404, feedforward (FF) echo canceller (EC) circuitry 406, crest factor reduction (CFR) and noise shaping (NS) circuitry 408, feedforward DAC 410, low pass filter (LPF) 412, combiner 414, amplifier 416, feedback (FB) analog-to-digital converter (ADC) 418, feedback echo canceller 420, combiner 422, receive (Rx) ADC 424, Rx amplifier 426, combiner 428, lowpass filter 430, feedforward DAC 432, crest factor reduction (CFR) and noise shaping (NS) circuitry 434, feedforward EC 436, receive (Rx) DSP 440, and interface circuitry 450.

In operation, a digital upstream signal generated by the TX DSP 402 is converted to analog by DAC 404 and then output onto the communication medium (e.g., coaxial cable) via diplexer 438. Concurrently, a downstream signal is received from the medium, amplified by amplifier 426, converted to a digital signal by Rx ADC 424, combined with signal 421 in combiner 422, and processed by receive DSP 440 to generate the received signal output from the transceiver 402 (e.g., onto an Ethernet local area network).

In operation, the feedback path comprising amplifier 416, ADC 418, and echo canceller 420 attempts to cancel the ALI by synthesizing a 180° out-of-phase approximation of the ALI present in signal 425 such that when signals are combined in combiner 422, the ALI is canceled. In practice, however, the ACI resulting from the upstream signal being transmitted by the cable modem 112ₙ reduces the effectiveness of the feedback path in cancelling ALI.

To reduce the ACI and achieve better ALI cancelation, the example transceiver 402 comprises two feedforward echo cancellation paths. The first feedforward echo cancellation path comprising feedforward echo canceller 436, CFR & NS circuit 434, DAC 432 and LPF 430 generates a 180° out-of-phase synthesized approximation of the ACI present in the received signal 421 such that the ACI is canceled in combiner 428. Similarly, the second feedforward echo cancellation path comprising feedforward echo canceller 406, CFR & NS circuit 408, DAC 410 and LPF 412 generates a 180° out-of-phase synthesized approximation of the ACI present in the feedback signal 405 such that the ACI is canceled in combiner 414.

The effectiveness of the feedforward echo cancellation paths is limited by the dynamic range of the feedforward DACs 410 and 432. Accordingly, the CFR & NS circuits 408 and 434 are used to mitigate this, as for example, described in the above-incorporated United States patent application titled “Echo Cancellation Leveraging Out-Of-Band Frequencies,” which is incorporated herein by reference.

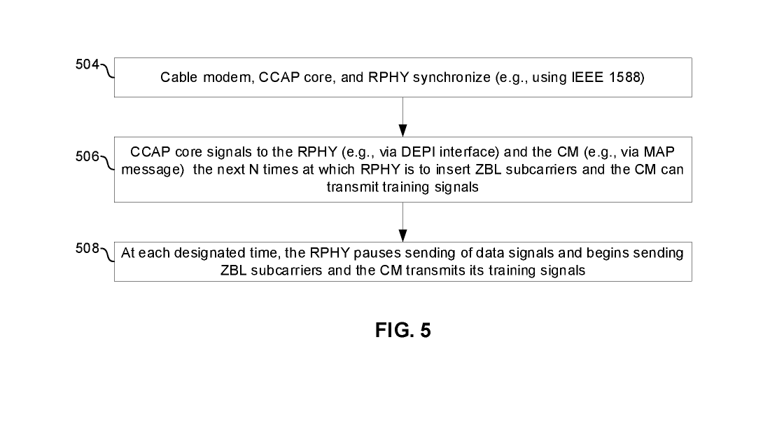

FIG. 5 is a flow chart illustrating an example process for coordinated training of cable modems in a full-duplex DOCSIS network. The process begins in block 404 in which the cable modem 112, the fiber node 104, and the CCAP core 102 are synchronized. This may be achieved, for example, using IEEE 1588 or other suitable protocol(s).

In block 506, the CCAP core 102 signals to the fiber node 104 (e.g., via a control channel of a downstream external PHY interface (DEPI)) and to the cable modem 112 (e.g., on one or more MAP messages) one or more timeslots at which the fiber node 104 is to transmit zero-bit-loaded (ZBL) subcarriers onto the cable 105.

In block 508, during each of the timeslots designated in block 406, the fiber node 104 transmits ZBL subcarriers onto cable 105 and the cable modem 112ₙ may transmit training signals for training its echo cancellation circuitry. The training signals may comprise, for example, scattered pilots and/or continuous pilots, with each pilot transmitted at a power that is low enough such to ensure that the power of the training signals at other cable modems 112 on the network is below a determined threshold.

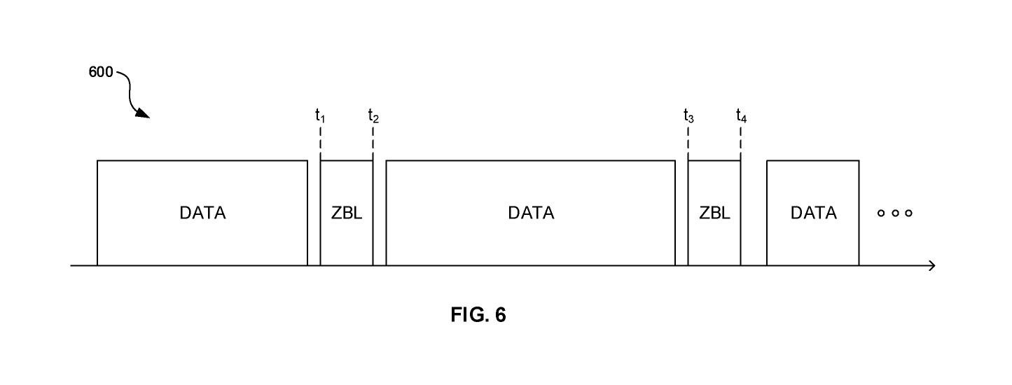

For example, referring to the example of FIG. 6, at block 506, prior to time t1, the CCAP core 102 signals to the fiber node 104 and the cable modem 112 that ZBL subcarriers are to be transmitted during the timeslot from t1 to t2 and the timeslot from t3 to t4. Then, in block 508, during the timeslot from t1 to t2 the fiber node 104 transmits the ZBL subcarriers and the cable modem 112 may transmit echo cancellation training signals.

In accordance with an example implementation of this disclosure, a remote PHY (e.g., 104) comprises circuitry operable to communicate with a converged cable access platform (CCAP) (e.g., 102) and a plurality of cable modems (e.g., 112₁-112₅) in accordance with Data Over Cable Service Interface Specification (DOCSIS®) (e.g., DOCSIS 3.1). The remote PHY comprises buffer circuitry (e.g., 306) operable to buffer signals to be transmitted to one or more of the plurality of cable modems. The remote PHY may comprise subcarrier insertion circuitry (e.g., 304) operable to manipulate the contents of the buffer circuitry such that the remote PHY is scheduled to transmit, during a determined time interval, subcarriers having determined characteristics. The subcarriers having determined characteristics may be zero-bit-loaded subcarriers. The subcarrier insertion circuitry may comprise a pseudo random binary sequence generator for generating the zero-bit-loaded subcarriers. The remote PHY may comprise time synchronization circuitry operable to participate in a synchronization protocol for synchronization of clocks of the remote PHY device, the CCAP, and the plurality of cable modems. The remote PHY device may comprise circuitry operable to receive instructions from the CCAP, where the instructions identify the determined time interval (e.g., time t1 to t2 in FIG. 6). The remote PHY may comprise circuitry operable to configure the subcarrier insertion circuitry to insert the subcarriers having determined characteristics into the buffer circuitry at a buffer position corresponding to the determined time interval. The CCAP may comprise circuitry operable to determine the determined time interval (e.g., select a time interval that will have least impact on subscriber experience (e.g., based on latency, throughput, etc.) based on past, current, and/or expected traffic) and communicate the determined time interval to the remote PHY and the plurality of cable modems.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting. As used herein, the term “based on” means “based at least in part on.” For example, “x based on y” means that “x” is based at least in part on “y” (and may also be based on z, for example).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the methods described herein.

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system comprising:
a remote PHY that comprises circuitry operable to communicate with a converged cable access platform (CCAP) and a plurality of cable modems in accordance with Data Over Cable Service Interface Specification (DOCSIS®) and that comprises:
buffer circuitry operable to buffer signals to be transmitted to one or more of the plurality of cable modems; and
subcarrier insertion circuitry operable to manipulate the contents of the buffer circuitry such that the remote PHY is scheduled to transmit, during a determined time interval, subcarriers having determined characteristics.

2. The system of claim 1, wherein the subcarriers having determined characteristics are zero-bit-loaded subcarriers.

3. The system of claim 2, wherein the subcarrier insertion circuitry comprises a pseudo random binary sequence generator for generating the zero-bit-loaded subcarriers.

4. The system of claim 1, wherein the remote PHY comprises time synchronization circuitry operable to participate in a synchronization protocol for synchronization of clocks of the remote PHY device, the CCAP, and the plurality of cable modems.

5. The system of claim 1, wherein the remote PHY device comprises circuitry operable to:
receive instructions from the CCAP that identify the determined time interval; and
configure the subcarrier insertion circuitry to insert the subcarriers having determined characteristics into the buffer circuitry at a buffer position corresponding to the determined time interval.

6. The system of claim 1, comprising the CCAP.

7. The system of claim 6, wherein the CCAP comprises circuitry operable to determine the determined time interval and communicate the determined time interval to the remote PHY and the plurality of cable modems.

8. A method comprising:
in a remote PHY that comprises circuitry operable to communicate with a converged cable access platform (CCAP) and a plurality of cable modems in accordance with Data Over Cable Service Interface Specification (DOCSIS®):
buffering, in buffer circuitry of the remote PHY, signals to be transmitted to one or more of the plurality of cable modems; and
manipulating, by subcarrier insertion circuitry of the remote PHY, the contents of the buffer circuitry to cause the remote PHY to transmit, during a determined time interval, subcarriers having determined characteristics.

9. The method of claim 8, wherein the subcarriers having determined characteristics are zero-bit-loaded subcarriers.

10. The method of claim 9, comprising generating, by the subcarrier insertion circuitry, the zero-bit-loaded subcarriers using a pseudo random binary sequence generator.

11. The method of claim 10, comprising participating, by time synchronization circuitry of the remote PHY, in a synchronization protocol for synchronizing clocks of the remote PHY device, the CCAP, and the plurality of cable modems.

12. The method of claim 10, comprising:
receiving, by circuitry of the remote PHY device, instructions from the CCAP that identify the determined time interval; and
configuring, by circuitry of the remote PHY device, the subcarrier insertion circuitry to insert the subcarriers having determined characteristics into the buffer circuitry at a buffer position corresponding to the determined time interval.

13. The system of claim 12, comprising:
determining, by the CCAP, the determined time interval; and
communicating, by the CCAP, the determined time interval to the remote PHY and the plurality of cable modems.
